(19) United States
(12) Patent Application Publication
(10) Pub. No.: US 2003/0103231 A1
(43) Pub. Date: Jun. 5, 2003

(54) Printing system

(76) Inventors: Shell S. Simpson, Boise, ID (US); Ward S. Foster, Boise, ID (US); Kris R. Livingston, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/998,650

(22) Filed: Dec. 3, 2001

(51) Int. Cl. B41J 1/00; G06F 15/00; H04N 1/00

(52) U.S. Cl. 358/1.15; 358/402

(57) ABSTRACT

A printing system that includes a personal computer and a printer is described. The printer includes a local control panel and operates both as a server and a printer. The printer serves a program to the personal computer upon request. The program enables the personal computer to print a document using the printer. The program also enables the personal computer to display a virtual printer control panel while the printer is printing the document. The user of the personal computer can access various features of the printer by interacting with the virtual printer control panel.

### BACKGROUND

Personal computers are often connected to a printer over a communication link in order to enable network printing. The user of the PC can make use of the printer to print a document.

Typically, the printer will include a local control panel. The user of the PC can interact with the local control panel in order to control certain aspects of the printer function. For example, the PC user may make use of the local control panel to cancel his/her print job that is presently being processed by the printer. Additionally, the local control panel may include one or more display devices that can provide the PC user with valuable information. For example, the control panel may provide the PC user with the status of his/her print job that is presently being processed by the printer.

Typically, in order for a PC user to access the local control panel of a printer, the PC user first must walk over to the printer. Unfortunately, walking over to the printer can be an inefficient use of the user's time. In some cases, the printer may even be located in an area that is inaccessible to the PC user. Thus, in some circumstances, a PC user may be unable to access the local control panel of a printer. What is needed is an improved way to provide a remote user (such as a PC user) easier access to the local control panel of a printer.

### SUMMARY

According to one embodiment, the invention provides a computer implemented method. The method may include, for example, the steps of: causing a first print job to be transmitted to a printer, the printer having at least one user input key; automatically displaying on the computer an image of the key while the printer is processing the first print job; and in response to receiving a selection of the key image, causing the printer to perform a function.

According to another embodiment, the invention provides a computer readable medium embodying a program of instructions for causing a computer to perform method steps. The computer is remotely connected to a printer having at least one user input key. The method steps may include, for example, transmitting a print job to the printer; automatically displaying on the computer an image resembling the user input key only while the printer is processing the print job; and in response to a selection of the image, causing the printer to initiate a function.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A is a block diagram of a computing system that incorporates an embodiment of the invention;

FIG. 1B shows the layout of a local printer control panel in the present embodiment;

FIG. 2 is a flow diagram illustrating how a user of a PC in the system can create a job document;

FIG. 3 is a flow diagram illustrating the operation of the PC to request and run Web content;

FIG. 4 is a flow diagram illustrating the operation of the PC under the direction of the Web content;

FIG. 5 provides an example of a GUI that may be displayed by the PC while operating under the direction of the Web content; and

FIG. 6 is an example of a job status page that may be displayed by the PC while operating under the direction of the Web content.

### DESCRIPTION

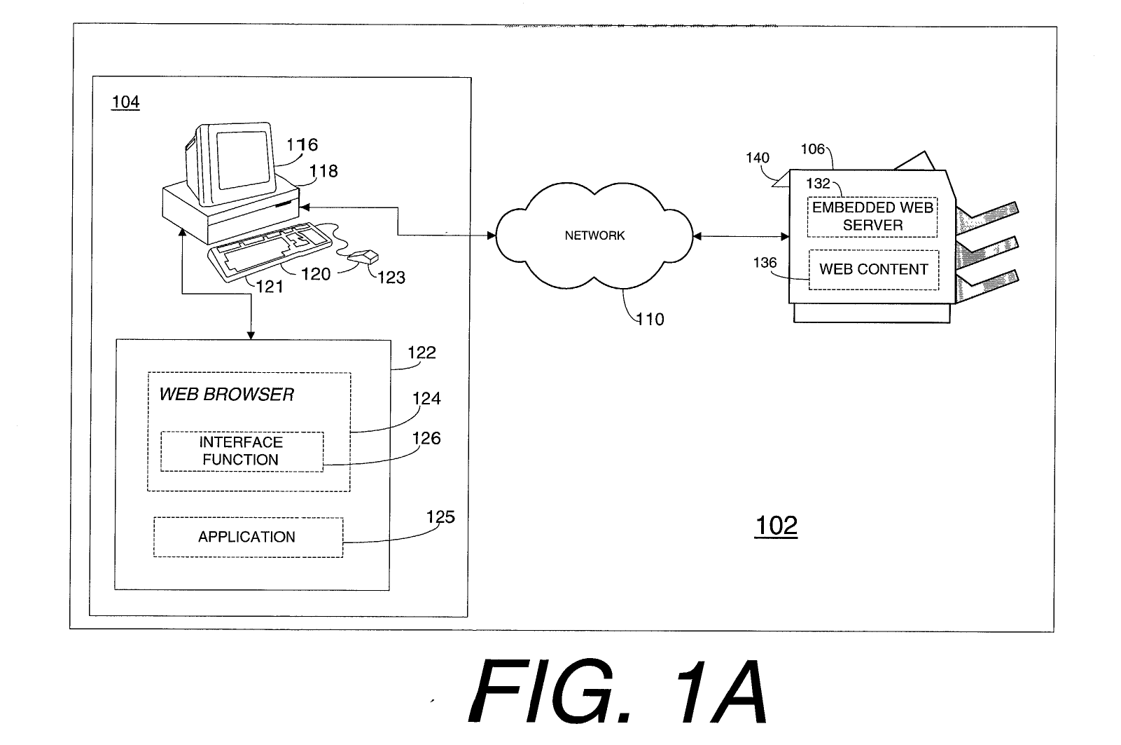

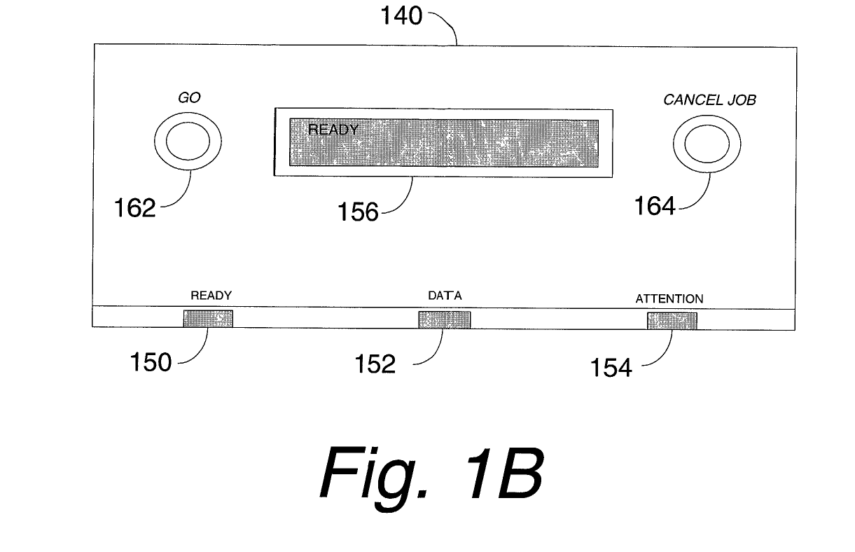

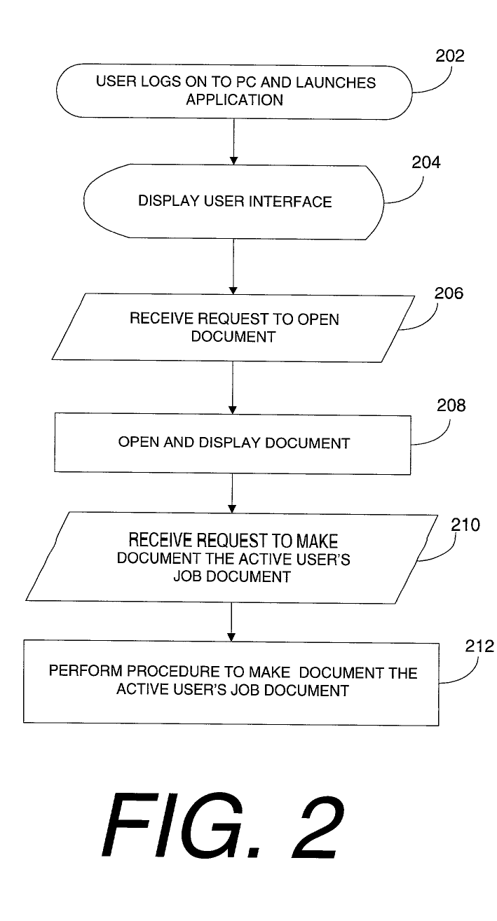

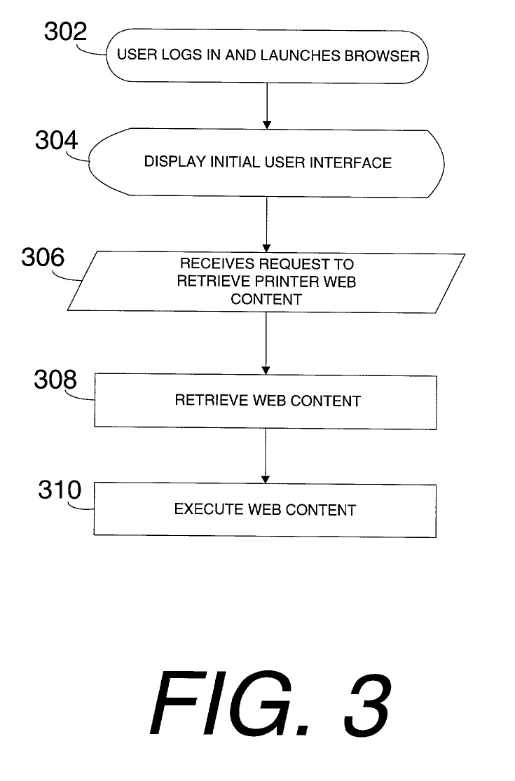

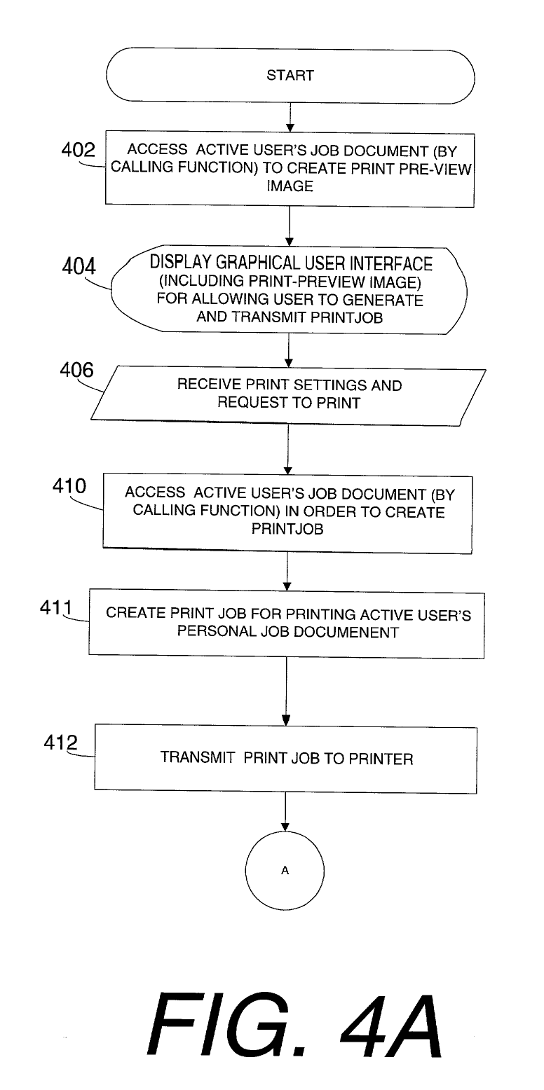

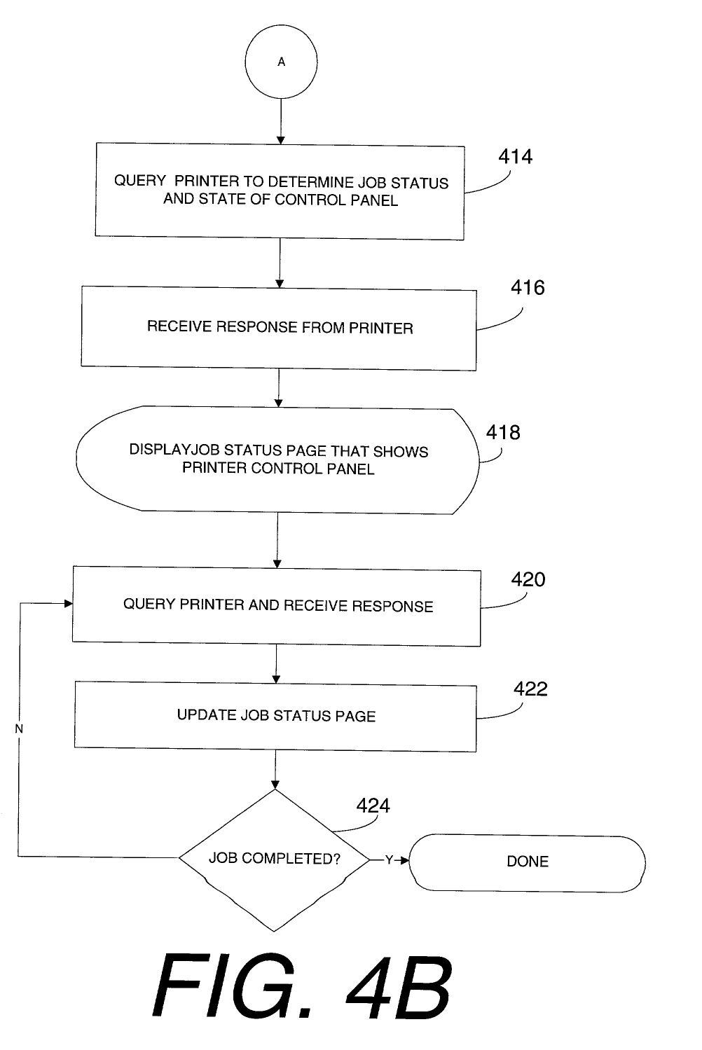

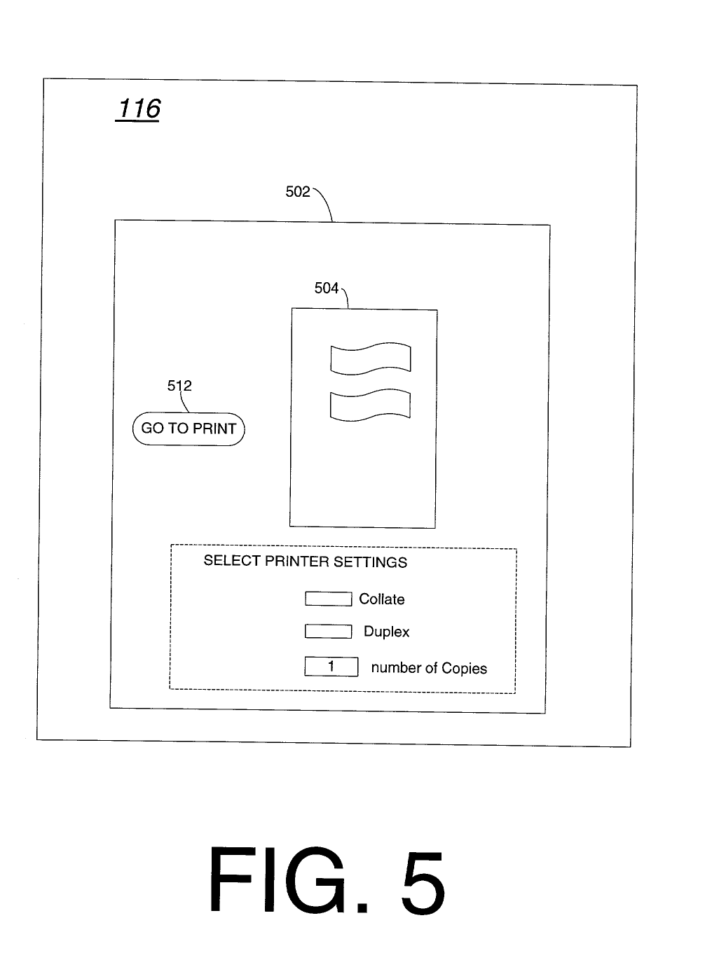

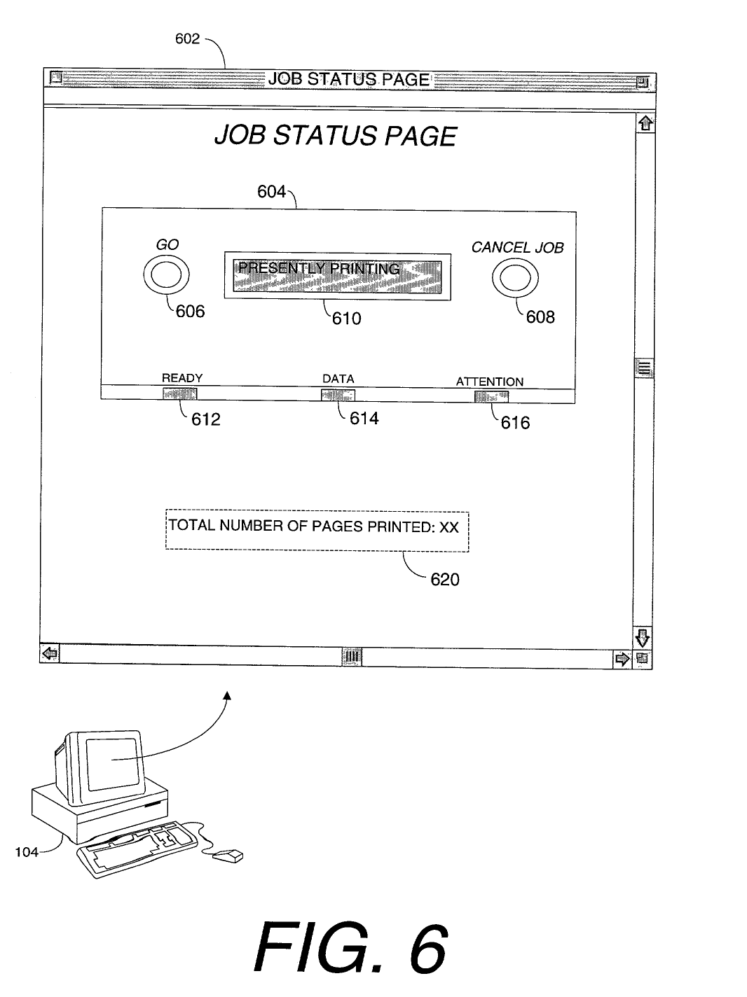

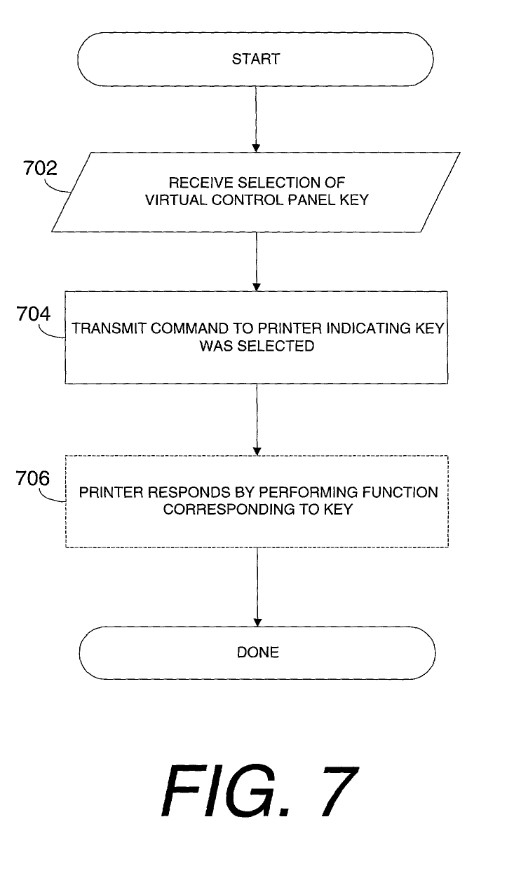

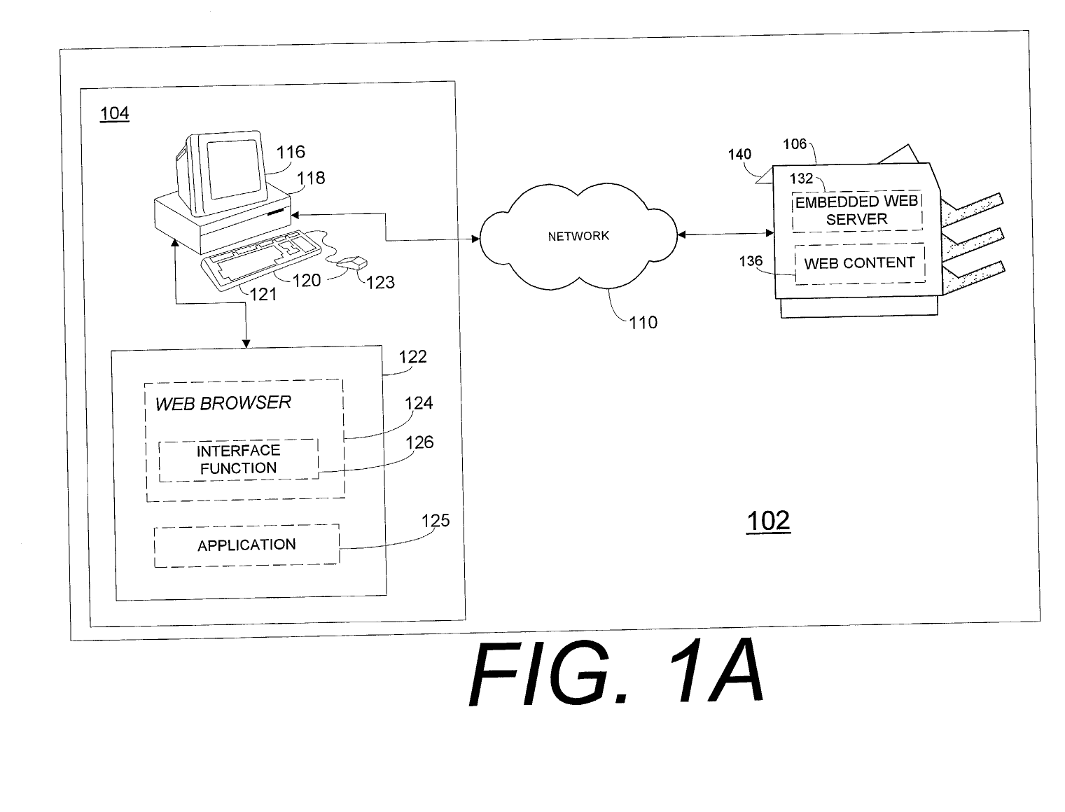

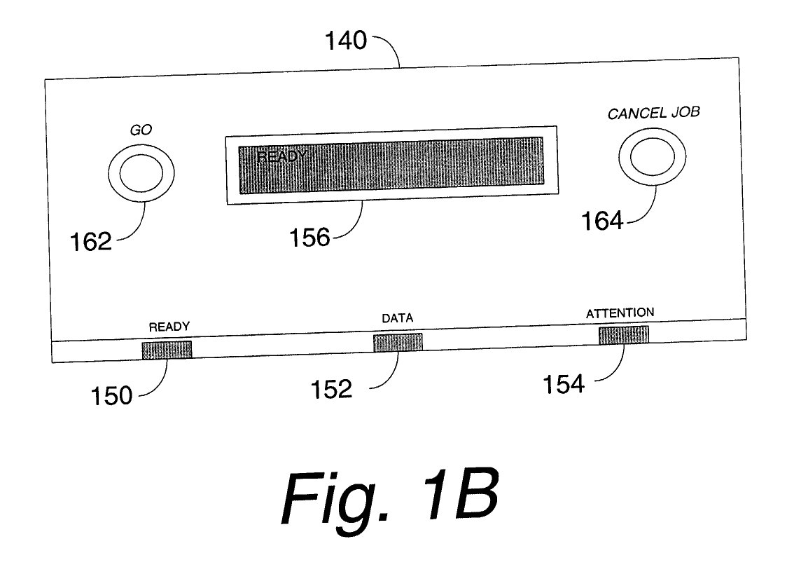

As shown in FIG. 1A, for purposes of illustration, the invention is embodied in a novel computing system 102. The computing system 102 includes a personal computer (PC) 104 and a printer 106 all connected to a network 110. The network 110 may represent, for example, an intranet, a series of networks, the Public Internet, a wireless network(s), etc., or some combination thereof.

In this embodiment, the PC 104 runs a local operating system, such as a version of Windows or Windows NT. Each user of the PC 104 is assigned a user name and a unique password. In order for a user to access the PC 104, the user first logs on. This involves the user establishing his/her online identity by inputting his/her assigned user name and password. For ease of discussion, a user presently logged into the PC 104 may be referred to as the “active user”.

In the present embodiment, there exists a special classification of electronic documents. Documents that fall into this classification are referred to herein as “job documents”. Each job document is linked to a unique user's online identity on the PC 104. A job document that is linked to a particular user's online identity may be referred to as being that user's “personal” job document. The active user's personal job document is referred to herein as the “target” job document.

As will be seen below, the target job document is the document that can be accessed by certain Web based services (such as the Web based printing service described below).

As shown, the PC 104 includes a display monitor 116, a processing unit 118, user input devices 120 and a memory 122. The user input devices 120, in this embodiment, include a mouse 121 and a keyboard 123.

Stored in the memory 122 is a Web Browser 124 and a word processing application 125. The processing unit 118 can retrieve and execute these two applications upon receiving an appropriate request from the user. The Web Browser 124 enables the PC 104 to run “Web content” and to function as a Web client in the system 102. As used herein, the phrase “Web content” refers to a program of computer readable instructions that may be executed by a Web Browser. Thus, for example, Web content may be a set of instructions written in any of the following languages (the following is a non-exhaustive list): HTML, Java, JavaScript, C-Sharp code, etc.

The Web browser 124 includes a program interface function (PI function) 126. Web content running in the browser 124 can call the PI function 126 in order to access the “target” job document.

It is noted that the call to invoke the PI function 126 is device independent and is defined by a standard. For ease of discussion, the call to invoke the PI function 126 may be referred to herein as the “get_job_doc” call. The standard that defines the call may be referred to herein as the “Web Imaging” standard.

To illustrate the operation of the PI function 126 consider the following example. Assume user “A” designates document “A” to be his/her personal job document. Assume also that User “B” designates document “B” to be his/her personal job document. Under these conditions, when user “A” is the active user, document “A” is the target job document. Therefore, Web content will access document “A” by calling the PI function 126 when user “A” is the active user. When, however, user “B” is the active user, document “B” is the target job document. Therefore, Web content will access document “B” by calling the PI function 126 when user “B” is the active user.

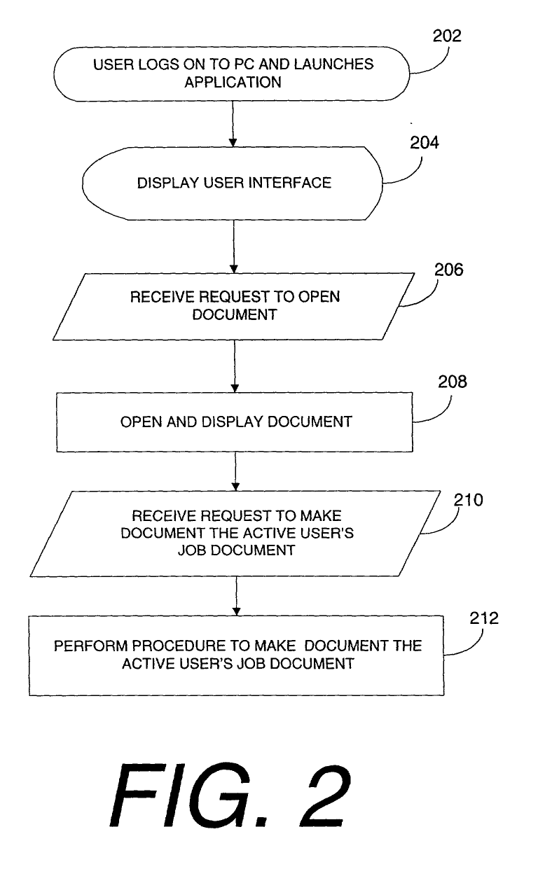

It is noted that one way for a user to designate a document to be his/her “personal job document” is by use of the word processing application 125. FIG. 2 is a flow diagram illustrating this functionality.

Referring now to FIG. 2, a user is assumed to log on to the PC 104 and to then launch the application 125 (Step 202). Upon being launched, the application 125 operates to display an initial graphical user interface (application GUI) (step 204). The application GUI provides various menus and options. A user can interact with the application GUI to create a new document or open an existing document. The application GUI further allows a user to input a request to make the document, presently open in the application 125, the user's personal job document.

At step 206, the application 125 is assumed to receive a user request to open a particular document. At step 208, the application 125 responds to the request by opening and displaying the document.

At step 210, the user inputs a request to make the open document his/her personal job document. In response to this user request, the application 125 follows a pre-determined procedure to make the document the user's personal job document (step 212). This procedure may involve modifying information associated with the user that is stored on PC 104 (or in some other location) so that the PI function 126 (which has direct or indirect access to that information) will operate to link Web content to the document whenever the present user is the active user.

It is noted that certain aspects of the procedure followed in step 212 may be governed by the Web imaging standard mentioned above. This standard may specify the formatting of job documents. The standard, for example, may specify that all job documents are to be filed in a (portable document file) PDF format. Thus, step 212 may involve converting the document into a predetermined file format.

Other aspects of the procedure, however, may be governed by user preferences (e.g., the storage location of the job document). It is contemplated, for example, that the user may be given the option to store his/her personal job document locally or in a remote location.

Turning again to FIG. 1A, the printer 106 includes a control panel 140 and an embedded Web server 132. The embedded Web server 132 can serve Web content 136 to Web clients, via the network 110, upon receiving an appropriate request. Multiple Web clients can access the Web content 136. In some implementations, the Web content 136 is generated dynamically. In other implementations, the Web content 136 is permanently stored in a local memory.

In general, the Web content 136 is intended to enable clients to print a document by using the printer 106. In this manner, the printer 106 provides a Web based printing service. The Web content 136 issues the “get_job _doc” call to access a document to print. Thus, the Web content 136 enables the PC 104 to print the target job document (i.e., active user's personal job document).

Various features of the printer 106 can be accessed through the control panel 140. FIG.1B shows the layout of the control panel 140 in the present embodiment. Referring now to FIG. 1B, the control panel 140 includes four display devices: a “ready” indicator light 150, a “data” indicator light 152, an “attention” indicator light 154 and a display 156. Additionally, the control panel 140 includes two input keys: a “go” key 162 and a “cancel job” key 164.

The indicator lights are used to indicate certain information to the walk-up user. Table 1 provides the meaning of each indicator light.

TABLE 1

| LIGHT | INDICATION (WHEN LIGHT IS ON) |
|---|---|
| Ready Light 150 | The printer 106 is ready to print |
| Data light 152 | The printer 106 is presently processing a print job |
| Attention light 154 | Acton is required. See the display 156 for details. |

The display 156 provides the walk-up user with various messages. For example, the display 156 may provide the walk-up user with an indication of whether the printer 106 is presently printing a job, the identity of the output tray that is presently receiving the job, etc.

A walk-up user can select the input keys in order to cause the printer 106 to perform particular functions. In the present embodiment, selecting the go key 162 causes the printer 106 to print any data presently residing in the printer's buffer. Selecting the “cancel job” key 164 causes the printer 106 to cancel the print job that the printer 106 is presently processing.

It is to be understood that in other embodiments, the printer control panel layout may be significantly different than the one just described.

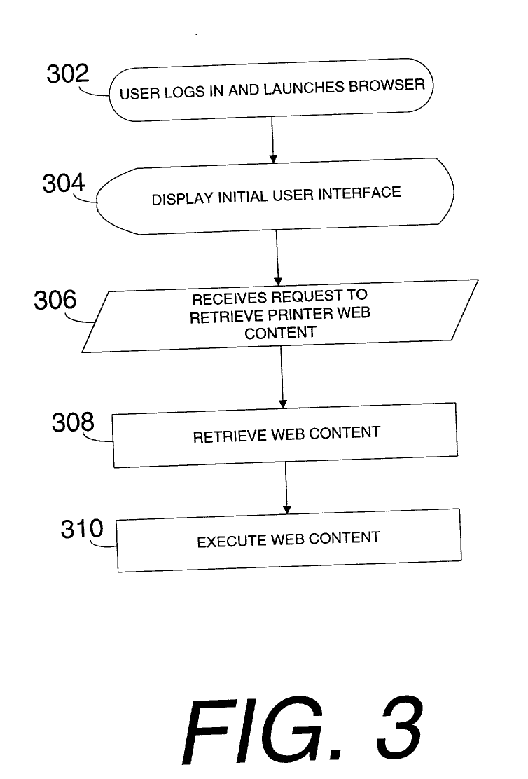

FIGS. 3-5 are flow diagrams illustrating how a user of the PC 104 can make use of the printing service provided by the printer 106. It will be assumed in the following discussion that the user has previously selected a document to be his/her personal job document.

Turning first to FIG. 3, the user logs into the PC 104 and then launches the Web Browser 124 (step 302). Upon being launched, the Web Browser 124 displays an initial graphical user interface (step 304).

The user can interact with the graphical user interface to request the Web content 136. The Browser 124 receives this user request at step 306. In response, the Browser 124 retrieves the Web content 136 by sending an appropriate request to the printer 106 (step 308). At step 310, the Web Browser 124 executes the Web content 136.

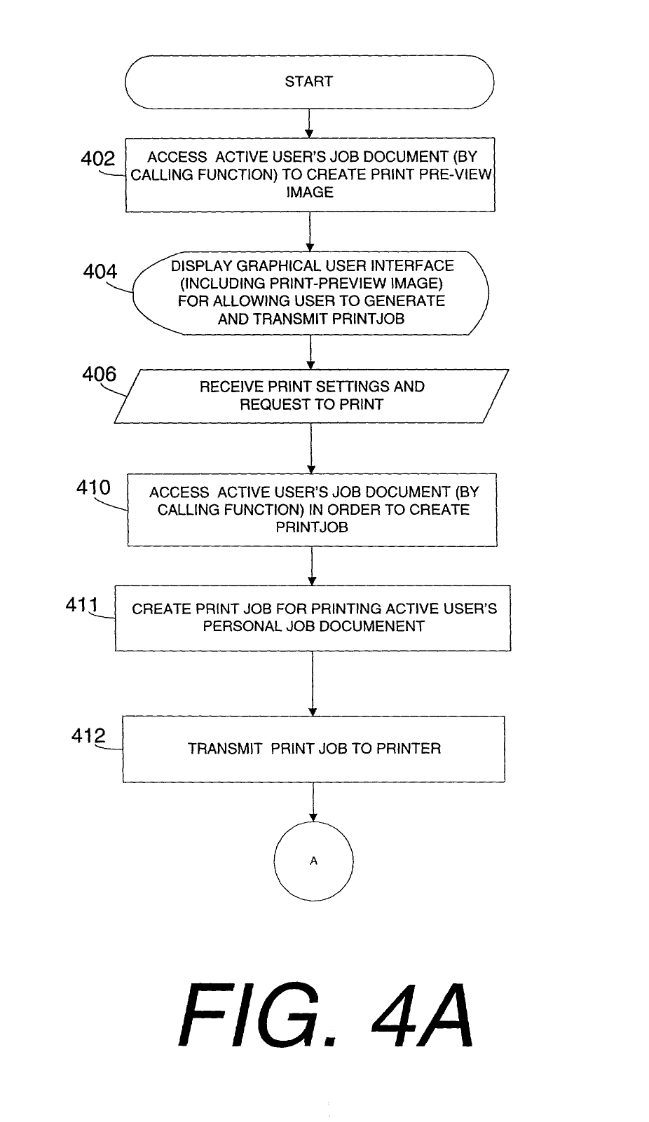

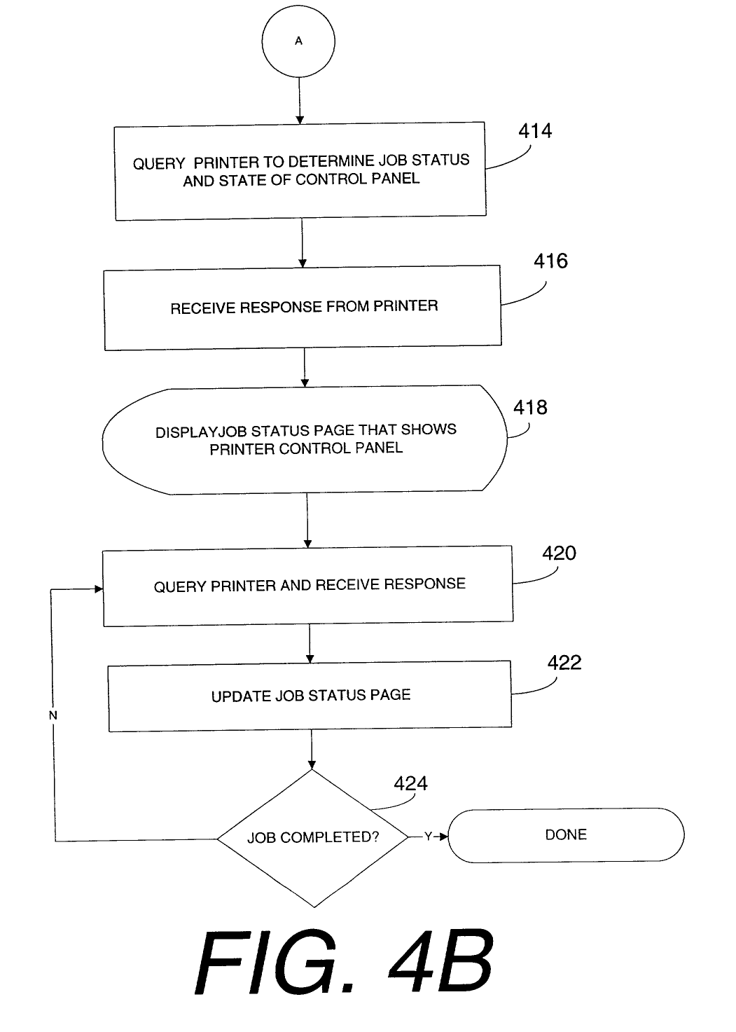

FIG. 4 is a flow diagram illustrating the operation of the Web content 136 at step 310. Turning now to FIG. 4, the Web content 136 accesses the active user's personal job document (i.e., the target job document) by calling the PI function 126 (step 402).

Next, the Web content 136 operates to display a graphical user interface (GUI) that allows the user to select various printing options that are offered by the printer 106 (step 404). Additionally, the GUI includes a print-preview image of the target job document. The print-preview image is based upon the imaging information received at step 402.

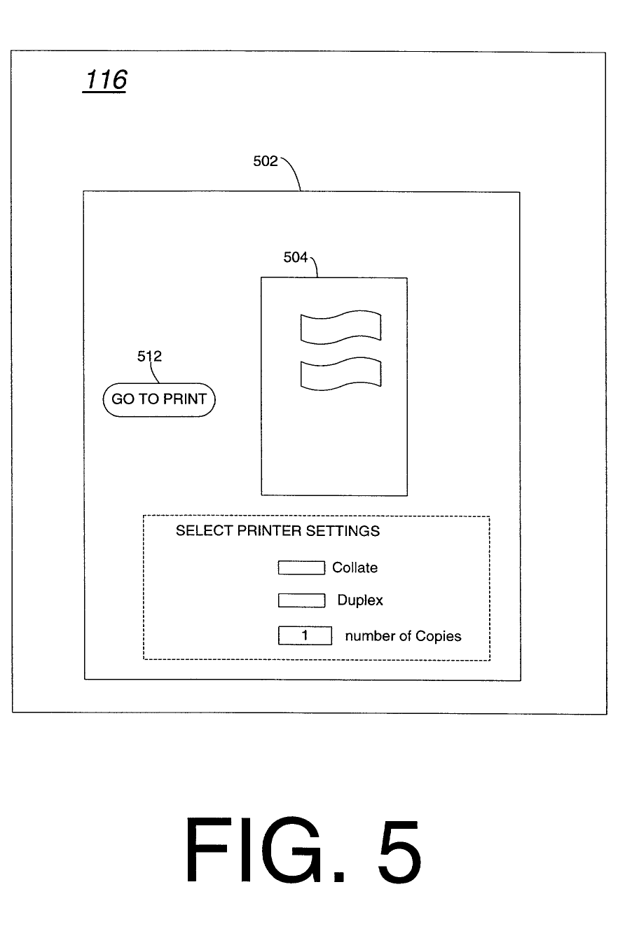

FIG. 5 provides an example of a GUI 502 that may be displayed at step 404 assuming the printer 106 offers document collation, duplex printing and multi-copy printing. In this example, the GUI 502 is a single Web page. As shown, the GUI 502 also allows the user to select various print options. For example, the GUI 502 allows the user to select a document collation option and a duplex printing option. In addition, the user can enter the number of copies he/she wishes to print.

The GUI 502 also includes a print preview image 504. The print preview image 504 provides a visual representation of how the target job document will be printed using the printer 106. The print preview image 504 is based upon the imaging information received at step 402.

After the user has set his/her desired print settings, the user can then request the target job document be printed by selecting the “go to print” button 512.

Referring again to FIG. 4, it is assumed that the user interacts with the GUI displayed at step 404 in order to select his/her desired print settings and to request the active user's personal job document be printed. The PC 104 receives this user input at step 406.

In response to this user input, the Web content 136 accesses the target job document again by calling the PI function 126 (step 410). The Web content 136 uses the imaging information received at step 410 to create a print job (step 411). The print job is suitable to print the target job document according to the print settings received at step 406. The print job may or may not comprise the actual graphical data to be printed. In some circumstances the print job may instead contain references to the graphical data to be printed.

At step 412, the Web content 136 causes the print job to be transmitted to the printer 106 via the network 110. The printer 106 receives the print job and begins processing it. For ease of the following discussion, the print job that was transmitted at step 412 may be referred to herein as the “target print job”.

At step 414, the Web content 136 queries the printer 106 to determine the present status of the target print job and to determine the present state of the control panel 140.

At step 416, the PC 104 receives a response from the printer 106 to the query. The response may include the following information:

a) The total number of pages of the target print job that have been printed;

b) whether the printer has successfully printed the target job.

c) the message(s) (if any) that is presently being displayed on the local control panel 140;

d) whether or not the ready indicator light 150 is presently on;

e) whether or not the data light 152 is presently on; and

f) whether or not the attention light 154 is presently on.

At step 418, the Web content 136 causes the computer 104 to display a Web page. For ease of discussion, this Web page may be referred to herein as the “job status” page. The job status page includes an image of the local control panel 140 of the printer 106.

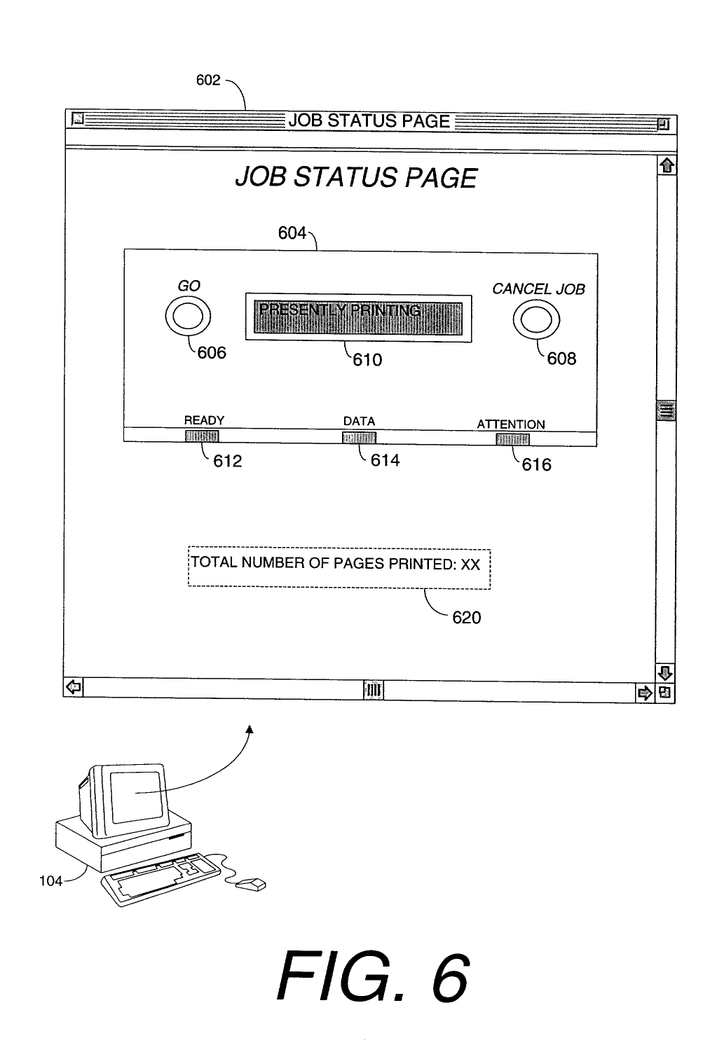

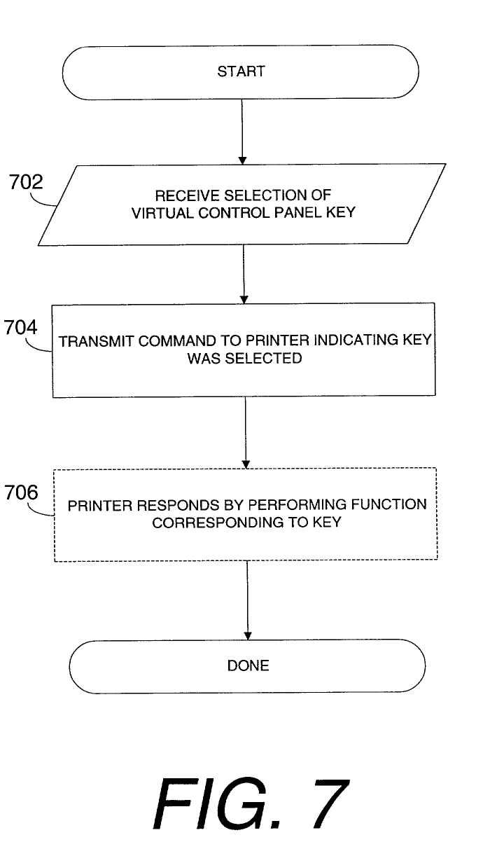

FIG. 6 provides an example of a job status page 602 that may be displayed at step 418. As shown, the job status page 602 includes an image 604 of the local control panel 140. The image 604 may alternatively be referred to herein as the “virtual control panel” 604.

The virtual control panel 604 includes the following items:

a virtual go key 606,

a virtual “cancel job” key 608;

a virtual display 610;

a virtual “ready” light 612;

a virtual “data” light 614; and

a virtual “attention” light 616.

In this embodiment, the job status page also provides the total number of pages that have been presently printed of the target print job (box 620).

In the present embodiment, the virtual control panel 604 reflects the present state of the local control panel 140. For example, if the response received from the printer at step 416 indicates a particular message is presently being displayed by the display 156, the Web content 136 causes the virtual display 610 to display the same message. If the data light 152 is presently on, the Web content 136 causes the virtual data light 614 to be displayed in an “on” condition, and so on.

The Web content 136 continues to monitor the printer 106 on a periodic basis in order to determine the present status of the target job and the present status of the control panel 140 (step 420). As this information is received, the Web content 136 proceeds to update the job status page accordingly (step 422). For example, assume the response from the printer at step 420 indicates that the “attention” light 154 has been turned on. In response, the Web content 136 updates the job status page (at step 422) so that the virtual “attention” light 616 is shown in an “on” condition.

The Web content 136 continues to monitor the printer 106 and to update the job status page until the target job is successfully completed (step 424). When the target job is successfully printed, the operation of the Web content 136 ends and the virtual control panel is no longer displayed on the display monitor 116 (since it is no longer relevant to the user viewing the display monitor as his/her job is no longer being processed).

It is important to note that, in the present embodiment, the virtual control panel 604 is displayed only while the target job is being processed. Thus, the active user can only select the “virtual go key” 606 or the “cancel job” key 608 while his/her print job is being processed. This limits the active user's remote access to the capabilities of the local control panel and can serve to reduce interference with the normal operation of the printer. In this embodiment, access is limited to: a) those physically present at the printer; b) administrative staff; and c) a remote user while his/her job is being processed by the printer 106.

FIG. 7 illustrates the operation of the WEB content 136 and the printer 106 assuming the active user selects one of the virtual input keys while the target job is being processed. Turning now to FIG. 7, the active user is assumed to select one of the virtual input keys (i.e., the user selects either the virtual go key 606 or the virtual cancel job key 608). The Web content 136 receives this input at step 702.

In response to the input received at step 702, the Web content 136 transmits a command to the printer 106 (step 704). The command transmitted at step 704 indicates the identity of the virtual key that was selected.

In response to receiving the command, the printer 106 operates as though the corresponding key on the local control panel 140 was selected. Thus, if the command indicates that the active user has selected the virtual go key 606, the printer 106 responds as if the go key 162 on the control panel 140 was selected by a walk-up user. Therefore, if the command indicates that the active user has selected the virtual go key 606, the printer 106 responds by printing any data presently residing in the printer's buffer.

Selecting the go key may cause the printer to perform other functions. In some printer models, for example, the “go” key may be used in cause a printer to print a job on media size that is different than that specified by the job. For example, assume a print job directs the printer to print on A4 media. A4 media, however, is unavailable. Selecting the “go key” or selecting the corresponding “virtual go” key causes the printer to print this same job on an available media size (e.g., letter size). Thus, selecting the virtual go key, in some embodiments, may cause a printer to print a job on media of a size that is different than that specified by the job.

If the command transmitted at step 704 indicates that the active user has selected the virtual “cancel job” key 608, the printer 106 responds as if the cancel job key 164 on the control panel 140 was selected by a walk-up user. The printer 106, therefore, responds by canceling the processing of the target print job.

From the foregoing it will be apparent that the present invention provides a novel and advantageous printing system. The printing system provides the user of a printer access to the local control panel of the printer while the user is using the printer to print a document. This is accomplished without the user having to walk over to the printer. Thus, the present invention provides for a more efficient printing system and can result in saving the user valuable time. Furthermore, the present invention can be used to provide the user with access to the printer local control panel in situations wherein the printer itself is inaccessible to the user. For example, the present invention is well suited to improve printing over the public Internet. In such an environment, the invention may be used to provide the user with access to the printer local control panel even if the printer itself is located half-way around the world with respect to the user. Additionally, the concerns of the administrator are met by limiting remote access to the control panel to only those end-users actively engaged in printing, thus the administrator has less concern regarding interference with the normal operation of the printer.

It is noted that the Web imaging standard described above represents just one model that enables a user to designate a document that he/she wishes to be accessed by Web based services. There are other models that can be used that also provide a user with this capability. For example, the operation of the client to allow a user to make a job document and to link the job document to Web content may be accomplished as a cooperative effort between two or more devices.

For example, the user may designate a job document to his/her personal job document by interacting with a remote server via his/her personal computer. According to one specific implementation, the remote server (document server) provides a user with a means for selecting a document to be his/her job document. Upon receiving the selection, the document server operates to link the selected document to an identifier (user ID) assigned to the user. The user ID may be the user's login name and password. The user ID is subsequently used to link the Web service to the user selected document. For example, when the user requests access to the service, the service provider (e.g., the printer Web server 132) requests the user input his/her ID. The service provider then makes use of this information to access the user's selected document from the document server. In this manner, therefore, the Web server is able to access the user's pre-selected job document and use that document to synthesize Web content (that enables document printing) based on that access. The Web content is then transmitted to the client.

It is important to also note that the present invention may be embodied in the form of a “computer readable medium”. For example, a memory that stores (either temporarily or permanently) the Web content just described may be considered an embodiment of the invention. It is also noted that the phrase “computer readable medium” can refer to any medium that can contain, store or propagate computer readable instructions. Thus, in this context, computer readable medium may refer to a medium such as a CD ROM or to signals that are used to communicate the computer readable code over a network, such as the Public Internet. A computer readable medium may also refer to a carrier wave.

Although several specific embodiments of the invention have been described and illustrated, the invention is not to be limited to specific forms or arrangements of parts so described and illustrated. For example, the printer Web server described above may be provided by a remote server that is not embedded in the printer. Also, the Personal computer may alternatively represent a personal digital assistant (PDA). The invention is limited only by the claims and the equivalents thereof.

What is claimed is:

1. A computer implemented method, comprising:
(a) causing a first print job to be transmitted to a printer, the printer having at least one user input key;
(b) automatically displaying on the computer an image of the at least one user input key while the printer is processing the first print job; and
(c) in response to receiving a selection of the at least one user input key image, causing the printer to perform a function.

2. The method of claim 1, wherein the printer is configured to perform a first function when the key is selected by a walk-up user and step (c) is performed by causing the printer to perform the first function.

3. The method of claim 1, wherein the printer is configured to respond to a selection of the key by canceling the job presently being processed by the printer, and step (c) is performed by causing the printer to cancel the processing of the first print job.

4. The method of claim 1, wherein the first print job directs the printer to print on media having a first set of dimensions; the printer is configured to respond to a selection of the key by printing the first print job on media having a different set of dimensions; and step (c) is performed by causing the printer to print the first print job on media having the different set of dimensions.

5. The method of claim 1, wherein the printer includes a local display device for displaying information to a user and the method further comprising:
(d) automatically displaying on the computer an image of the display device while the printer is processing the first print job.

6. The method of claim 5, wherein the image of the display device indicates the information presently being provided by the display device.

7. The method of claim 1, wherein the computer is connected to the printer over a network.

8. A server, comprising:
(a) means for receiving a request from a client;
(b) means for responding to the request by transmitting a program of computer readable instructions to the client, the program for enabling the client to:
i) use a specific printer to print a document, the printer having a user input key; and
ii) automatically display an image of the key while the printer is printing the document; and
iii) in response to receiving a user selection of the key image while the printer is printing the document, cause the printer to perform a particular function.

9. The server of claim 8, wherein the server is embedded in the printer.

10. The server of claim 8, wherein the printer is configured to respond to a selection of the input key while the printer is printing the document by canceling the printing of the document; and wherein the function includes canceling the printing of the document.

11. The server of claim 8, wherein the function includes causing the printer to print the document on media having a particular dimension.

12. The server of claim 8, wherein the printer includes a local display device for providing information to a walk-up user and the program is further for enabling the client to:
iv) display an image of the local display device while the printer is printing the document.

13. The server of claim 8, wherein the client is a personal computer connected to the server over a network.

14. The server of claim 8, wherein the program is Web content.

15. A computer readable medium embodying a program of instructions for causing a computer remotely connected to a printer to perform method steps, the printer having at least one user input key, the method steps comprising:
(a) transmitting a print job to the printer;
(b) automatically displaying on the computer an image resembling the user input key only while the printer is processing the print job; and
(c) in response to a selection of the image, causing the printer to initiate a function.

16. The computer readable medium of claim 15, wherein the function includes canceling the print job.

17. The computer readable medium of claim 16, wherein the printer is configured to respond to a selection of the user input key while the printer is processing the print job by canceling the print job.

18. The computer readable medium of claim 15, wherein the printer includes a local display for providing information to a walk up user and the method steps further comprising:
(d) automatically displaying on the computer a virtual display while the printer is processing the print job; and wherein the virtual display resembles the local display and indicates the same information presently being indicated by the local display.

19. The computer readable medium of claim 15, wherein the printer includes at least one indicator light for indicating information to a walk-up user and the method steps further comprising:
(d) automatically displaying on the computer an image that resembles the present state of the indicator light while the printer is processing the print job.

20. A printing system comprising:
(a) a printer having at least one user input key; and
(b) a computer connected to the printer over a network, the computer including:
(b.1) apparatus for transmitting a print job to a printer;
(b.2) apparatus for automatically displaying on the computer an image of the input key while the printer is processing the print job; and
(b.3) apparatus for responding to a selection of the image by causing the printer to perform a pre-determined function.

21. The system of claim 20, wherein the printer is configured to respond to a selection of the user input key by canceling the print job that is presently being processed; and wherein the predetermined function includes canceling the processing of the print job.

22. The system of claim 20, wherein the printer is configured to respond to a selection of the user input key performing the pre-determined function.
